(19) United States
(12) Patent Application Publication
(10) Pub. No.: US 2010/0230484 A1
(43) Pub. Date: Sep. 16, 2010

(54) Electronic Business Card

(76) Inventors: Yuan-Chih TSAI, Hsinchu (TW); Tzu-Ming Wang, Hsinchu (TW); Ted-Hong Shinn, Hsinchu (TW)

Correspondence Address: Portal IPR Services, P.O. Box 223205, Chantilly, VA, 20153, US

(21) Appl. No.: 12/422,174

(22) Filed: Apr. 10, 2009

(30) Foreign Application Priority Data
Mar. 12, 2009 (TW) 098108108

(51) Int. Cl. G06F 17/00; G06F 3/041

(52) U.S. Cl. 235/375; 345/173

(57) ABSTRACT

An electronic business card includes a data transmitting module, a storing module and a flexible display. The data transmitting module is used to transfer and receive at least a data. The storing module that is electrically connected to the data transmitting module is used to store the data, which has been received or will be transmitted by the data transmitting module. The flexible display used to display the data stored in the storing module is electrically connected to the storing module. In the electronic business card, the flexible display may improve portability and reduce the power-consumption, thus a use convenience of the electronic business card can be improved.

### BACKGROUND

This application claims priority to a Taiwan application No. 098108108 filed Mar. 12, 2009.

1. Field of the Invention

The invention relates to an electronic business card, and more particular, to an electronic business card with flexibility.

2. Description of the Related Art

The first step of people knowing each other is exchanging business card in various business actions. That is, business card is the medium for knowing each other.

Traditionally, business card is made of printing and cutting thicker paper, so the paper business card may consume paper and increase cost. Further, the paper business card is difficult to collect, manage and carry, and it also takes up a lot of space.

An electronic business card displaying information by liquid crystal display panel is provided in prior art for solving the aforementioned problems. However, since the liquid crystal display panel is thick and the shape thereof can not be changed, the portability of the prior electronic business card is limited hereto and cannot be improved. Furthermore, the power-consumption of the liquid crystal display panel is large, so the use life of the electronic business card is difficult to prolong.

Therefore, it is one of the important issues for the people skilled in this art that how to increase the portability and decrease the power-consumption of the electronic business card.

### BRIEF SUMMARY

The invention is directed to an electronic business card with flexibility, so it is more convenient to user.

The invention provides an electronic business card comprising a data transmitting module, a storing module and a flexible display. The data transmitting module is used for transmitting and receiving data. The storing module is electrically connected to the data transmitting module for storing the data going to be transmitted or received by the data transmitting module. The flexible display is electrically connected to the storing module for displaying the data stored in the storing module.

The electronic business card of the invention uses the flexible display without backlight source, so the electronic business card may be easily to carry and has low power-consumption.

In order to make the aforementioned and other objects, features and advantages of the invention comprehensible, preferred embodiments accompanied with figures are described in detail below.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram illustrating the electronic business card according to an embodiment of the invention.

FIG. 2 is a schematic view of the electronic business card according to an embodiment of the invention.

FIG. 3 is a diagram illustrating the electronic business card according to another embodiment of the invention.

FIG. 4 is a diagram illustrating the electronic business card according to another embodiment of the invention.

### DETAILED DESCRIPTION

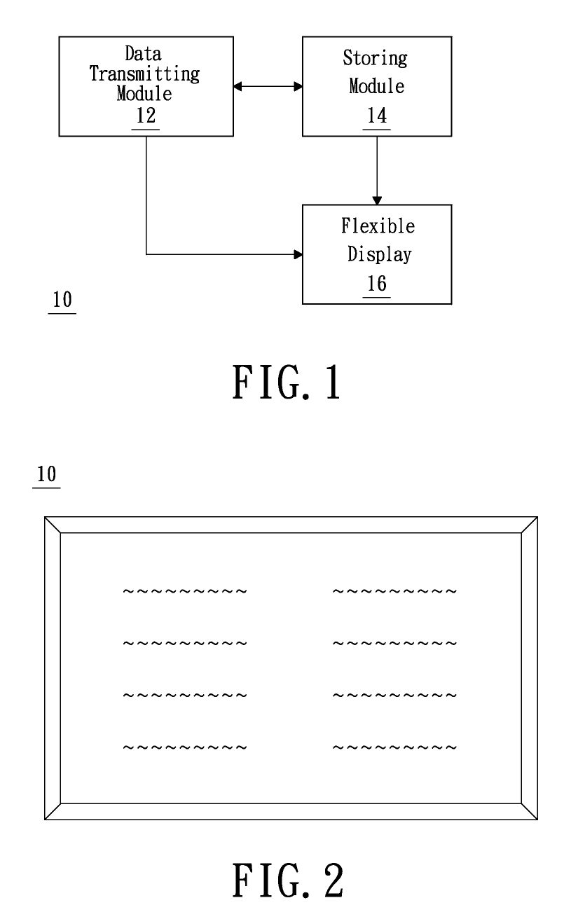

FIG. 1 is a diagram illustrating the electronic business card according to an embodiment of the invention. Referring to FIG. 1, the electronic business card 10 comprises a data transmitting module 12, a storing module 14 and a flexible display 16. The data transmitting module 12 is used for transmitting and receiving data. Specifically, the data received by the data transmitting module 12 may be personal information of user or customer, such as name, phone number, sex, birthday, name of company, address of company and fax number of company.

In detail, the data transmitting module 12 may be wireless data transmitting module, such as antenna module, wireless network module, radio frequency identification module, Bluetooth module or infrared ray module. Alternately, the data transmitting module 12 may also be wired data transmitting module, such as universal serial bus (USB), module, wired network module or memory card reading module. In other words, users may transmit the personal information thereof to the electronic business card 10 or exchange the personal information to others through the wireless or wired data transmitting module 12.

Referring to FIG. 1, the storing module 14 is electrically connected to the data transmitting module 12 for storing the data received thereby. Specially, users also can transmit the data stored in the storing module 14 to external storage devices through the data transmitting module 12 for reserving the data for backup.

The flexible display 16 is electrically connected to the storing module 14 for displaying the data storing in the storing module 14. Furthermore, the flexible display 16 may also be electrically connected to the data transmitting module 12 and the storing module 14 at the same time, as shown in FIG. 2. Therefore, the flexible display 16 may display the data received by the data transmitting module 12 or the data stored in the storing module 14. Moreover, the flexible display 16 may be microcapsule electro-phoretic display, microcup electro-phoretic display, quick response-liquid powder display, micro electromechanical systems display, electro-wetting display, organic electro-luminescence display or cholesteric liquid crystal display.

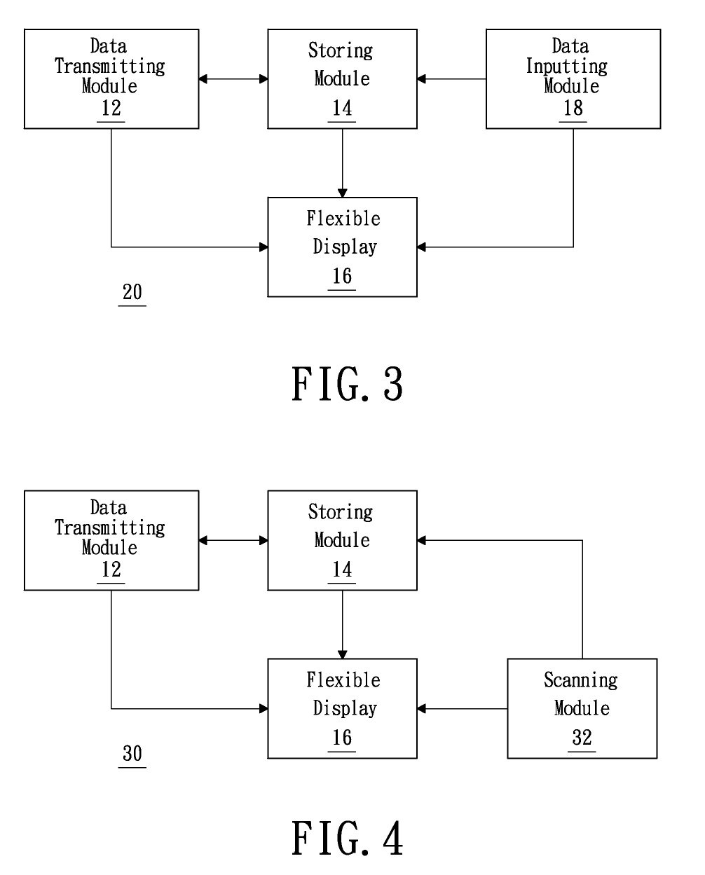

As shown in FIG. 3, the electronic business card 20 of the invention not only transmits or receives data through the data transmitting module 12, also receives data through the data inputting module 18. In detail, the data inputting module 18 may comprises handwriting device and/or keyboard. Users may input the personal information thereof or of the customer to the electronic business card 20 through the data inputting module 18. The data inputting module 18 is electrically connected to the storing module 14, so the data inputted by users through the data inputting module 18 may be stored in the storing module 14.

Specially, the electronic business card 20 of the invention not only may externally connect to the data inputting module 18 for providing users to input data, also may use touch panel with the flexible display 16. Therefore, it can enhance the functions of the electronic business card 20 without affecting the convenience thereof.

Additionally, as shown in FIG. 4, for further increasing the using convenience of the electronic business card of the invention, the electronic business card 30 may also comprise a scanning module 32 used for generating image data and transmitting it to the storing module 14. Consequently, users may store the information written on the paper business card in the electronic business card 30 through the scanning module 32. Furthermore, the scanning module 32 also may be electrically connected to the flexible display 16, so that the image data generated by scanning may be transmitted to the flexible display 16 for displaying.

In summary, the electronic business card of the invention is used the flexible display. Since the flexible displays generally are reflective display without backlight source, the electronic business card of the invention is more convenient to carry and has low power-consumption.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electronic business card, comprising:
a data transmitting module, used for transmitting and receiving at least a data;
a storing module, electrically connected to the data transmitting module and used for storing the data; and
a flexible display, electrically connected to the storing module and used for displaying the data.

2. The electronic business card as recited in claim 1, wherein the flexible display may be a microcapsule electro-phoretic display, a microcup electro-phoretic display, a quick response-liquid powder display, a micro electromechanical systems display, an electro-wetting display, an organic electro-luminescence display or a cholesteric liquid crystal display.

3. The electronic business card as recited in claim 1, further comprising a scanning module, electrically connected to the storing module or the flexible display and used for generating an image data and transmitting the image data to the storing module or the flexible display.

4. The electronic business card as recited in claim 1, wherein the data transmitting module may be a wireless data transmitting module or a wired data transmitting module.

5. The electronic business card as recited in claim 4, wherein the data transmitting module comprises at least one of an antenna module, a wireless network module, a radio frequency identification module, an Bluetooth module and an infrared ray module.

6. The electronic business card as recited in claim 4, wherein the data transmitting module comprises at least one of a universal serial bus transmitting module, a wired network module and a memory card reading module.

7. The electronic business card as recited in claim 1, further comprising a data inputting module, electrically connected to the storing module for inputting data.

8. The electronic business card as recited in claim 7, wherein the data inputting module comprises at least one of a handwriting device and a keyboard.

9. The electronic business card as recited in claim 1, wherein the flexible display comprises a touch panel.

10. The electronic business card as recited in claim 1, wherein the flexible display is further electrically connected to the data transmitting module for displaying the data received by the data transmitting module.
